(19) United States
(12) Patent Application Publication
(10) Pub. No.: US 2003/0176985 A1
(43) Pub. Date: Sep. 18, 2003

(54) Thermal control method for computers

(76) Inventor: Song Bor Chen, Taipei (TW)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 10/098,541

(22) Filed: Mar. 18, 2002

(51) Int. Cl. G06F 15/00

(52) U.S. Cl. 702/132

(57) ABSTRACT

A thermal control method for computers, using the advanced configuration and power interface as the main improvement. The method of the invention introduces a program design in the operating system (OS) and the basic input output system (BIOS), so as to provide a proper cooling method.

### FIELD OF THE INVENTION

The invention relates to a thermal control method for computers, and particularly to a thermal control method for computers using mainly an advanced configuration and power interface.

### BACKGROUND OF THE INVENTION

The advanced configuration and power interface (ACPI) is a power management interface jointly developed by Intel, Microsoft, and TOSHIBA, which allows the operating system (OS) to follow a definite rule in managing the power consumption of peripheral devices. For example, it causes the computer to enter a power saving mode or stop operations when the hard disk or the monitor has been idle for a certain period of time, until the user begins using the computer again. Currently, the ACPI is the new standard for power and configuration management in computer systems, including hardware, software, basic input output system (BIOS), and the operating system.

Even though ACPI is a power management interface, it does not provide a function for the user to set or change it. The user usually has to follow the preset values already set by the system to control the thermal management of the computer. However, according to different usage situations, the necessary method of cooling may be different. Therefore, the issue of how to allow the user to set thermal management, so as to choose the best method to implement cooling according to the situation of use thus requires a simple and convenient solution, in order to allow the desktop or notebook computer to be operated with more efficiency in thermal dissipation.

### OBJECT AND SUMMARY OF THE INVENTION

In light of the forgoing disadvantage, the invention introduces a thermal control method with ACPT as the main subject for improvement. The invention provides a method to introduce a proper cooling method through the operating system and the BIOS.

The thermal control method for computers through the operating system provided by the invention comprises the following steps:

When the temperature reaches a thermal control preset value, the system reads the respective cooling routine through a route of preset parameters, and then executes cooling. This step is repeatedly performed, and when the temperature reaches another thermal control preset value, the system again reads the respective cooling routine through the route of preset parameters, and then performs the cooling step.

The thermal control method for computer by BIOS provided by the invention comprises the following steps:

When the temperature reaches a thermal control preset value, the system reads the BIOS preset parameters and then executes the respective cooling step. This step is repeatedly performed, and when the temperature reaches another thermal control preset value, the system again reads the BIOS preset parameters and then performs the respective cooling step.

The detail description of the invention is illustrated by drawings in a later section.

### DETAILED DESCRIPTION OF THE PREFERRED EMBODIMENTS

In order to allow computers to be more automatic in power saving, and allow users to be able to independently operate the software and hardware according to the manufacturer's preset values or through a method set by the user, so as to achieve the effect of power saving, the invention provides a thermal control method for computers that is based on the ACPI, which writes a program to change and improve the existing thermal management method.

Operation of this ACPI management system and activation of the power management function of the operating system can only be engaged with hardware and peripheral devices of conforming specifications. In addition, the ACPI also provides a system event device of a general type for plug-and-play, as well as an interface for the configuration control. However, the ACPI does not support the power management function in BIOS. This invention has a clearly defined method of processing a thermal trip in the thermal management of ACPI, which is to totally hand over the task to the operating system. However, the processing of voltage and the speed of the fan is still performed by the BIOS.

Since Intel CPUs have a built-in semiconductor for monitoring the chip temperature, existing motherboards use this device to detect the CPU temperature, so when the CPU is in a state of normal voltage and normal operation, the high thermal energy generated by the execution of complicated instructions generally cause the motherboard to automatically enter the ACPI mode, and stop the system temporarily, so as to prevent the CPU from being damaged due to overheating. When the temperature reaches 135° C., the CPU stops all instructions and issues a continuous thermal trip signal (THERMTRIP) to the system until a reset signal is received (the system reboots the computer, or the user presses the reset button).

Currently, in order to enhance the CPU's operating efficiency, most computers raise the voltage slightly when the CPU becomes unstable, which also increases the CPU's thermal generation, and therefore creating the need for a thermal control method to effectively dissipate the heat. The process of thermal control for desktop computers is simple, because there is plenty of room in the host unit to accommodate the installation of a large thermal dissipation device. Therefore if the CPU's ambient temperature is too high, an extra thermal dissipation device can be installed to provide circulation to the ambient air around the CPU. However, it is not as simple for notebook computers, and for this reason, the method of the invention can change thermal dissipation with respect to the different devices.

The invention is a software solution that allows the user to choose according to personal preference either the default automatic mode preset by the operating system, or a user-defined mode. When the user-defined mode is chosen as the thermal control mode, the user can modify the two thermal preference modes provided by the ACPI specification, and then send the selected results to the operating system. The operating system can then perform the thermal control modes according to the sequence set by the user, so as to achieve the effects of thermal control and power saving.

The ACPI provides two modes for thermal control:

(1) Active cooling preference:

The emphasis is placed on thermal control, so when the action of thermal control is performed, cooling is actively engaged first, such as activation of the fan; then a passive cooling process such as a CPU throttle is engaged.

(2) Passive cooling preference:

The emphasis is placed on power saving, so when the action of thermal control is performed, cooling is passively engaged first, such as the CPU throttle; then the active cooling process such as activation of the fan is engaged.

These two methods can achieve the effect of thermal control. However, the activation of the fan consumes more power than the CPU throttle, which is a major consideration for power consumption of notebook computers and similar mobile computing devices. Currently, thermal management of operating systems and BIOS is pre-determined by the manufacturer at the time of purchase, which denies users the option of free choice.

A preferred embodiment is provided for describing the system and feasibility of the method introduced by the invention. Refer to FIG. 1, which is a schematic drawing of the thermal control method for computers as well as an explanation of the basic principles of the invention, and the explanation, that follows:

If the system is preset as an active thermal control, then when the computer temperature increases continuously, and the temperature detected by the thermal device 100 reaches a preset threshold, the system automatically activates the fan. If the temperature continues to increase, then the system throttles the CPU to bring down the CPU temperature.

Refer to FIG. 2, which is another schematic drawing of the thermal control method for computers as well as an explanation of the basic principles of the invention, and the explanation, that follows:

If the system is preset as a passive thermal control, then when the computer temperature increases continuously, and the temperature detected by the thermal device 100 reaches a preset threshold, the system automatically throttles the CPU to bring down the CPU temperature. If the temperature continues to increase, then the system automatically activates the fan.

Refer to FIG. 3, which is a flowchart of the mode of operating system management of the invention as well as an explanation of the procedure of the invention, and the explanation, that follows:

The invention provides an interface that allows the operating system to communicate with the BIOS. First, the user defines a cooling routine (step 200), then the system reads the cooling routine (step 210). The operating system and the BIOS communicate through a transmission of parameters, wherein the default value is coactively modified and then the related action is performed. If the temperature continues to increase, then the system executes the cooling step (step 220), and respectively activates the fan or throttles the CPU.

Refer to FIG. 4, which is a flowchart of the BIOS management mode of the invention as well as an explanation of the procedures of the invention, and the explanation, that follows:

Currently, the BIOS preset values still do not provide users the option of making changes freely. If the method introduced by the invention is adopted, the sequence of the active mode and passive mode can be changed by adjusting the BIOS program, and adjustments can also be made to the various parameters of thermal control. The BIOS provides the thermal method (step 300), and if it is different from the preset values (step 310), then a cooling routine is replaced (step 320). If it is the same as the preset values, then the cooling routine is not changed. After the setting is complete, if the system temperature reaches the preset thermal control value, then the system reads the cooling routine (step 210), and the system executes the cooling step (step 220) to respectively activate the fan or throttle the CPU.

### EFFECT OF THE INVENTION

Through the forgoing analysis of the technical solution provided by the invention, it is apparent that the method of the invention has many advantages in its practical application, which are as follows:

1. The user can choose different thermal control modes according to personal preference, so as to achieve the effect of power saving.

2. The thermal control method can be completely achieved by the software method without extra hardware costs.

3. The thermal control method can enhance the computer's functions and therefore its selling points, increasing its added value.

Although the invention has been described in detail using the preferred embodiments, the invention is not limited to the disclosed embodiments, so that any one who is skilled in the related areas, as long as the spirit and scope of the invention is not violated, may be able to make modest modifications. Therefore this invention's scope of protection shall adopt the designation in the scope of the patent application that will be provided at a later time.

### BRIEF DESCRIPTION OF THE DRAWINGS

FIG. 1 is a schematic drawing of the invention;

FIG. 2 is another schematic drawing of the invention;

FIG. 3 is a flowchart of the operating system management mode of the invention; and

FIG. 4 is a flowchart of the BIOS management mode of the invention.

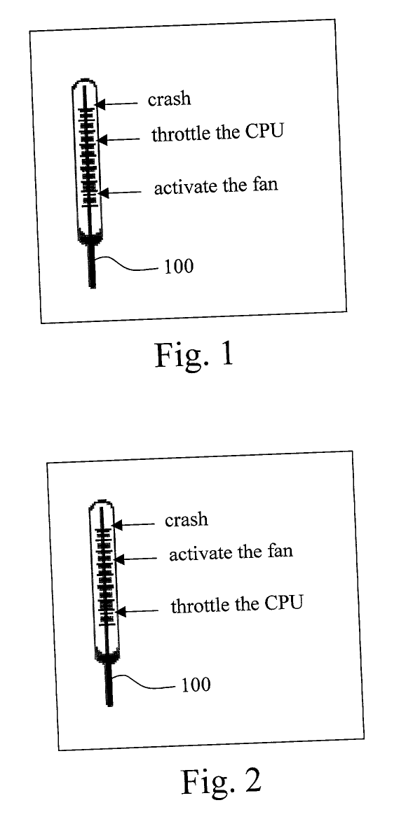

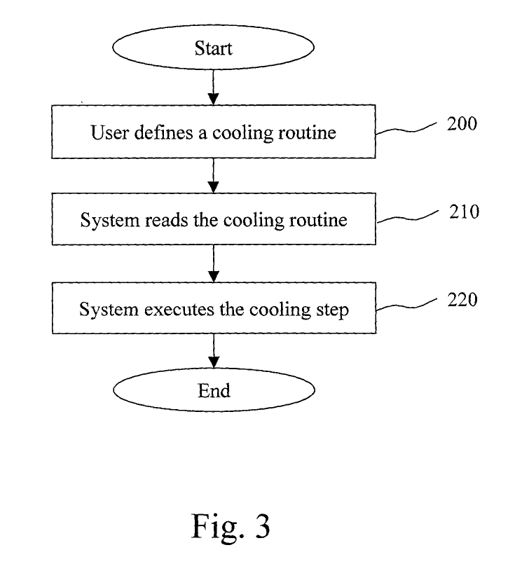

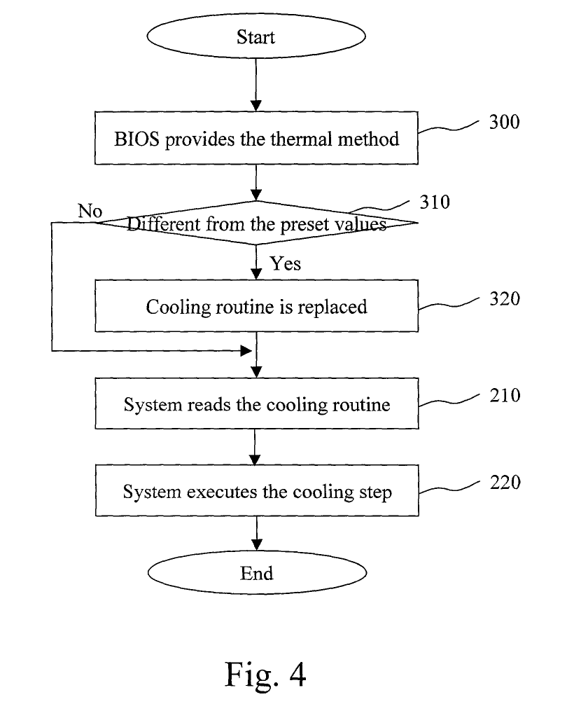

What is claimed is:

1. A thermal control method for computer, based on an advanced configuration and power interface (ACPI), and used in an operating system for a thermal control, wherein a user sets a plurality of thermal control preset values with respect to a cooling routine and a cooling step, which comprises the steps of:
the system reading the respective cooling routine and executing the respective cooling step when temperature reaches one of the thermal control preset values; and
repeating the foregoing step, the system again reads the respective cooling routine and executes the respective cooling step when temperature reaches another one of the thermal control preset values.

2. The thermal control method of claim 1, wherein the thermal control preset values are set by the operating system.

3. The thermal control method of claim 1, wherein the temperature is a system temperature.

4. A thermal control method for computer, based on an advanced configuration and power interface (ACPI), and used in a basic input output system (BIOS) for a thermal control, wherein a user sets a plurality of thermal control preset values with respect to a cooling routine and a cooling step, which comprises the steps of:
the system reading a BIOS preset parameter and executing the respective cooling step when the temperature reaches one of the thermal control preset values; and
repeating the foregoing step, the system again reads the BIOS preset parameter and executes the respective cooling step when the temperature reaches another one of the thermal control preset values.

5. The thermal control method of claim 4, wherein the thermal control preset values are set by the operating system.

6. The thermal control method of claim 4, wherein the temperature is a system temperature.
